(19) United States
(12) Patent Application Publication
(10) Pub. No.: US 2023/0097924 A1
(43) Pub. Date: Mar. 30, 2023

(54) CHIRAL PHOTONIC INK AND IRIDESCENT PRODUCTS

(71) Applicant: UNIVERSITY OF SOUTH CAROLINA, COLUMBIA, SC (US)

(72) Inventors: MONIROSADAT SADATI, ELGIN, SC (US); KYLE GEORGE, COLUMBIA, SC (US)

(21) Appl. No.: 17/866,137

(22) Filed: Jul. 15, 2022

Related U.S. Application Data
(60) Provisional application No. 63/245,462, filed on Sep. 17, 2021.

(51) Int. Cl. C09D 11/50; C09D 11/14; C09D 11/037; B33Y 10/00; B33Y 70/00; B29C 64/106

(52) U.S. Cl. CPC C09D 11/50; C09D 11/14; C09D 11/037; B33Y 10/00; B33Y 70/00; B29C 64/106; B29K 2001/08

(57) ABSTRACT

Optically active formulations useful as inks in extrusion-based deposition techniques and solids formed of the formulations are described. Formulations include a cellulose derivative in a chiral nematic phase and a polyethylene glycol interspersed with the cellulose derivative as stabilization to the cholesteric pitch of the chiral nematic phase. The inks can be utilized in direct ink writing processes to produce printed films or three-dimensional structures with long-lasting colors that stem from the nanostructure of the chiral nematic phase. The ink can include reactive monomers which can be polymerized to create optically active solid elastomers.

### CROSS REFERENCE TO RELATED APPLICATION

This application claims filing benefit of U.S. Provisional Patent Application Ser. No. 63/245,462, entitled “Chiral Photonic Inks For 3D Printing of Iridescent Architectures” and having a filing date of Sept. 17, 2021, which is incorporated herein by reference for all purposes.

### BACKGROUND

The exceptional optical properties of natural photonic microstructures such as those present in plants (e.g., marble berries) and animals (e.g., scarab beetle, chameleon, morpho butterfly) have drawn interest from a variety of industries for development of replacements to traditional pigments and dyes. Research has focused on lyotropic liquid crystalline compounds that can form photonic materials. For example, concentrated aqueous solutions of hydroxypropyl cellulose (HPC) form a chiral nematic liquid crystalline phase in which polymer chains self-assemble to form helicoidal microstructures similar to natural materials and that reflect visible light at wavelengths dictated by the spacing of the cholesteric pitch. In solution, hydrated chiral domains are malleable and display a macroscopic blue shift when compressed or strained, giving the solutions an optically responsive property. This phenomenon has been the focus of researchers in a variety of fields, such as those working to achieve responsive sensors for biomedical applications.

Unfortunately, the helical pitch of the cholesteric phase of HPC solutions is determined by the solution composition, and as such, is susceptible to change by solvent evaporation. Minor changes cause the reflected colors to blue shift, and while shear casting of solutions allows for the chiral nematic order to be preserved in solid films, the photonic properties are lost over time as slow solvent evaporation causes compression of the cholesteric pitch to scales on the order of UV wavelengths.

A variety of methods have been examined for preserving the chiral structure in the solid state to expand the practical application of these materials. Kinetic trapping, chemical crosslinking, and chemical alteration of the polymer side chains have been employed to preserve the photonic properties of the aqueous solutions. Unfortunately, these techniques have been primarily limited to the production of high wavelength emitting blue films. Moreover, by nature of the casting process used to obtain the films, randomly oriented cholesteric domains and variation in film thickness contribute to a matte appearance and discoloration of the dried films. Photonic 3D materials have been produced by altering the chemistry of the polymer side chains to allow for in-situ polymerization of iridescent solutions that maintained structural coloration in the solid state.

While the above describes improvement in the art, room for further improvement exists. For instance, the production of chiral nematic inks that can be utilized in 3D printing, for production of solid phase structures useful in a variety of applications that exhibit long-lasting, stable coloring across the visible spectrum would be of great benefit in the art.

### SUMMARY

According to one embodiment, disclosed is an optically active ink that includes a cellulose derivative in a chiral nematic phase. The optically active ink includes a solvent and the cellulose derivative in an amount of about 50 wt. % or greater. The optically active ink also includes a polyethylene glycol (PEG) in an amount of about 15 wt. % or less.

Also disclosed are solidified materials formed from the optically active inks. A solid state material can include a chiral nematic phase including a cellulose derivative in an amount of about 70 wt. % or greater and a PEG in an amount of about 30 wt. % or less. The solid state material can be of any size and shape, e.g., a film, a 3D structure, etc., and can reflect light in the visible spectrum, so as to appear with a discernable color in the visible spectrum.

Also disclosed are methods for forming an optically active structure. A method can include forming an ink that includes a lyotropic cellulose polymer, a PEG, and a solvent. The ink can include the lyotropic cellulose polymer in an amount such that the polymer spontaneously forms a chiral nematic phase. The method can also include depositing the ink on a substrate. The ink can be deposited at a uniform shear rate of about 5 sec⁻¹ or greater. Following the deposition and recovery of the chiral nematic phase, the deposited ink can be dried at a temperature of about 50° C. or greater, which can kinetically trap the chiral nematic phase of the cellulose polymer within the dried solid.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates PEG molecules interspersed between layers of cholesteric cellulose-based materials of a chiral nematic phase.

FIG. 2 schematically illustrates possible variations in optical properties of materials formed as described herein.

FIG. 3 schematically illustrates the cholesteric pitch dynamics of a hydroxypropyl cellulose (HPC)/water solution with change in solvent concentration.

FIG. 4 illustrates the intensity vs. wavelength characteristics for several polymer-stabilized chiral nematic HPC solutions.

FIG. 5 presents the peak reflected wavelength for several HPC and HPC/PEG solutions.

FIG. 6 presents water activity data for several HPC and HPC/PEG solutions.

FIG. 7 presents flow curves for HPC and HPC/PEG solutions containing PEG concentrations from 0 to 11 wt. %.

FIG. 8 presents normal stress difference (N₁) measurements obtained for HPC and HPC/PEG solutions containing PEG concentrations from 0 to 11 wt. %.

FIG. 9 presents the ratio of loss-to-storage modulus with shear forces for HPC and HPC/PEG solutions containing PEG concentrations from 0 to 9 wt. %.

FIG. 10 illustrates stress evolution with time in HPC and HPC/PEG solutions containing PEG concentrations from 0 to 9 wt. %. under simulated printing conditions.

FIG. 11 presents relaxation curves of HPC and HPC/PEG solutions containing PEG concentrations from 0 to 9 wt. % showing the recovery of the chiral nematic phase following simulated printing conditions.

FIG. 12 presents intensity vs. wavelength characteristics for several polymer-stabilized chiral nematic HPC solid structures.

FIG. 13 presents UV-VIS spectra for several polymer-stabilized chiral nematic HPC solid structures.

FIG. 14 presents field emission scanning electron microscope (FE-SEM) micrographs of film sections for casted samples.

FIG. 15 presents FE-SEM micrographs of film sections for printed samples.

FIG. 16 provides high resolution AFM micrographs of sections of printed samples.

FIG. 17 presents intensity vs. wavelength characteristics for several polymer-stabilized chiral nematic HPC solid structures.

FIG. 18 presents intensity vs. wavelength characteristics for several polymer-stabilized chiral nematic HPC solid structures.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

The present disclosure is directed to optically active formulations that can be utilized as inks in extrusion-based deposition techniques, e.g., 3D printing, for formation of solid architectures of any design, from simple to highly complex. Disclosed inks can display colors across the visible light spectrum (about 380 nm to about 750 nm wavelengths) and can be formed from sustainable, biocompatible materials that are relatively inexpensive and readily available. The source of color in disclosed inks stems from the nanostructure of the components themselves, and as a result, the inks can form optically responsive, solid-state products without the need for addition of any dyes or pigments. As such, the inks and products formed therefrom can maintain desired colors over extended periods of time without gradual fading, as is the case for materials that are optically active through incorporation of dyes or pigments. Through control and manipulation of content and processing parameters, disclosed materials can also be formed as “smart” materials that can display colors that are dependent on the viewing angle of the material and/or that can display dynamic colors based on environment.

The optically active materials disclosed herein incorporate a lyotropic cellulose derivative that, at suitable solvent concentration, can form a chiral nematic phase. Such lyotropic cellulose derivatives have been known previously and disclosed materials are not limited to any particular lyotropic cellulose derivative. For instance, a cellulose derivative of a formulation can include one or more cellulose ethers, one or more cellulose esters, or any combination thereof. By way of example, and without limitation, a cellulose derivative can include an alkyl cellulose (e.g., methyl cellulose, ethyl cellulose, ethyl methyl cellulose), a hydroxy alkyl cellulose (e.g., hydroxyethyl cellulose, hydroxypropyl cellulose, hydroxyethyl methyl cellulose, hydroxypropyl methyl cellulose, ethyl hydroxyethyl cellulose), a carboxy alkyl cellulose (e.g., carboxymethyl cellulose), an organic ester cellulose (e.g., cellulose acetate, cellulose triacetate, cellulose propionate, cellulose acetate propionate, cellulose acetate butyrate), an inorganic acid cellulose (e.g., nitrocellulose, cellulose sulfate), or any combination thereof. In one embodiment, an optically active material can include an alkyl cellulose such as hydroxypropyl cellulose (HPC), methyl cellulose, ethyl cellulose, or combinations thereof.

The molecular weight of the cellulose derivative is not particularly limited, provided it is capable of forming a chiral nematic phase in solution. For instance, the cellulose derivative can have a weight average molecular weight of from about 20 kDa to about 200 kDa, such as from about 25 kDa to about 150 kDa, or from about 30 kDa to about 125 kDa, in some embodiments.

In conjunction with the cellulose derivative, disclosed materials also include a polyethylene glycol (PEG). Without wishing to be bound to any particular theory, it is understood that in solution, a hydrogen bonding network can be developed between polymer chains of the cellulose derivative in the chiral nematic phase and PEG that naturally intersperses between layers of the chiral network, thereby forming a network of hydrogen bonds between the cellulose chains and the PEG chains. The PEG chains thus serve to stabilize the cellulose derivative chiral network. Upon removal of solvent, the PEG chains will maintain the stabilization function, preventing compression of the cholesteric pitch and loss of color of the materials. Incorporation of a PEG into the ink solution can thus provide a route for the preservation of the chiral nematic phase of the cellulose material following removal of the solvent. Moreover, the PEG can act as a plasticizer that can increase the flexibility of a solid product.

The molecular weight of the PEG is not particularly limited, provided it does not interfere with the formation of the chiral nematic phase in an ink. For instance, the PEG can have a weight average molecular weight of from about 100 Da to about 50 kDa, such as from about 150 Da to about 50 kDa, or from about 100 Da to about 20 kDa, in some embodiments. Mixtures of PEG can also be utilized, for instance, combinations of PEG of different molecular weights can be utilized.

An ink including the cellulose derivative component and the PEG component can include a suitable solvent. The choice of solvent can depend upon the particular cellulose derivative and PEG utilized. For instance, in some embodiments, an aqueous solvent can be utilized, while in others a binary solvent system or an organic solvent may be selected. Typical solvents can include, without limitation, water, ethanol, methanol, dichloromethane, acetone, furfuryl alcohol, dimethyl formamide, formic acid, glacial acetic acid, and mixtures thereof.

The lyotropic cellulose derivative can be combined with a suitable solvent and PEG in an amount such that the cellulose derivative can form a chiral nematic phase in the ink. In general, this will entail the formation of a relatively concentrated solution of the cellulose derivative, e.g., about 50 wt. % or greater, such as from about 50 wt. % to about 85 wt. %, or from about 55 wt. % to about 75 wt. %, in some embodiments.

The content of the PEG can likewise vary, generally depending upon the molecular weight of the PEG, with a higher molecular weight PEG being incorporated at a lower content and a lower molecular weight PEG being incorporated at a relatively higher content. Overall, the add-in amount of a PEG component can be about 15 wt. % or less of an ink, such about 13 wt. % or less, or about 11 wt. % or less, in some embodiments. For instance, a relatively high molecular weight PEG polymer, e.g., 10 kDa or greater, can be incorporated into an ink in an amount of about 5 wt. % or less, a mid-range PEG polymer, e.g., from about 1 kDa to about 10 kDa, can be incorporated into an ink in an amount of from about 0.3 wt. % to about 8 wt. %, and a lower molecular weight PEG polymer, e.g., about 1 kDa or less, can be incorporated into an ink in an amount of from about 0.1 wt. % to about 13 wt. %.

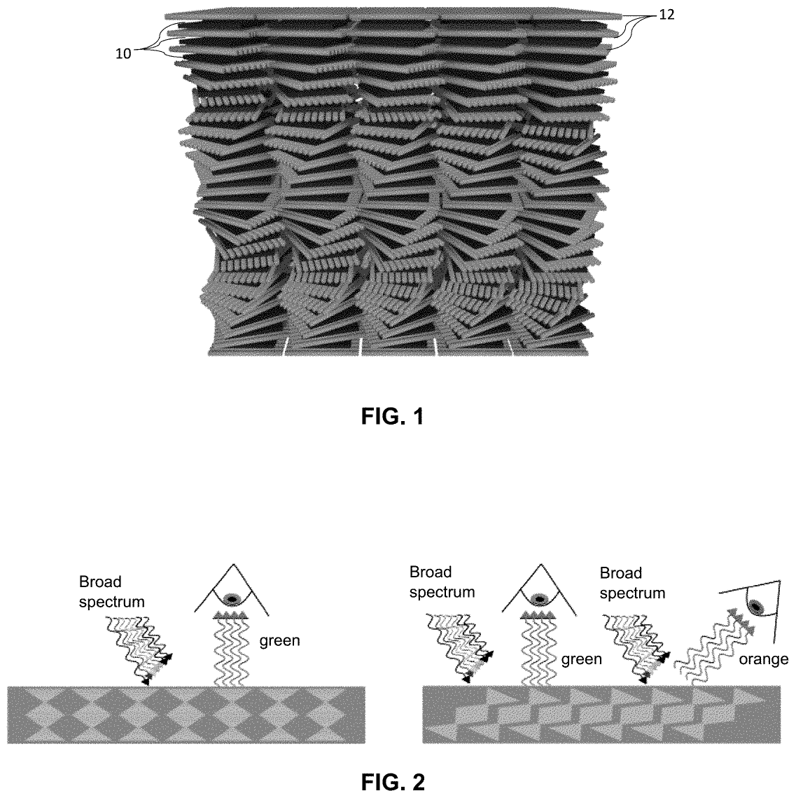

Following formation, the cellulose/PEG inks can exhibit a liquid-like/gel-like duality that allows the chiral phase to maintain a relatively stable pitch even at low water activity values (i.e., less free water content), e.g., a water activity of about 95 or less at a water concentration of about 40 wt. % or less. Without wishing to be bound to any particular theory, it is understood that this is the result of intermolecular bonding between hydroxyl groups of the cellulose derivative and etheric oxygen along the PEG backbone. As illustrated in FIG. 1, the formation of this network allows PEG chains 10 to be retained between the cholesteric layers 12. Upon removal of the solvent during drying, the PEG chains 10 will remain within the cholesteric phase where they can provide physical support to the cholesteric structure in the solid phase.

The cellulose/PEG inks can exhibit shear thinning behavior under shear rates of about 5 sec⁻¹ or greater. Under suitable shear, the cellulose chains of the chiral nematic phase can align to form a pseudo-nematic state and encourage shear thinning characteristics of the inks, leading to increased liquid-like behavior under shear. The shear thinning, increased liquid-like behavior of the inks at suitable shear rates allows for the inks to flow freely through and out of a deposition nozzle with minimal elastic instabilities, such as die-swell. Once the shear forces have been removed following deposition, the gel-like behavior of the inks can dominate and the deposited material can maintain its extruded geometry under its own weight. For instance, if an ink is extruded through a nozzle to form a ribbon or fiber-like geometry, the gel-like characteristics of the ink allows for the deposited material to remain in the extruded geometry prior to solvent removal.

Following deposition of an ink, the cellulose chains can spontaneously rotate and self-assemble in conjunction with the PEG to reform the polymer-stabilized chiral nematic phase from the pseudo-nematic state induced during deposition, thus reforming the stabilized cholesteric phase and providing the desired optical characteristics to the deposited materials in the desired geometry.

Such favorable properties of the inks make them ideal for a variety of high shear deposition techniques, e.g., industrial processing techniques such as 3D printing techniques. As is known, 3D printing techniques can be utilized to form structures of simple or complex geometry to any size scale. Moreover, 3D printing techniques can be tightly controlled, enabling deposition of materials with a specified geometry (thickness, height) throughout the entire design configuration. Such deposition control can provide a product with little or no deviation from design in structure characteristics (e.g., wall thickness, height, etc.).

In one particular embodiment, disclosed inks can be utilized in a direct ink writing (DIW) deposition technique. The inks can be designed to exhibit a wide variety of characteristics appropriate to DIW through modification of solution content, e.g., modification of particular cellulose derivative(s) included in the inks, PEG molecular weight and content in the inks, solvent selection and content in the inks, etc. Such variability combined with the variability of DIW parameters, including print speed, flow rate multiplier, filament dimensions, etc. can provide for precise control of a DIW process using disclosed inks to produce filaments with a wide possible variation in the degree of structural order of the chiral nematic phase as well as variation in the overall deposition characteristics. Using computer aided design, a limitless number of complex geometries can be developed and implemented in the DIW process with a high degree of precision.

As mentioned, a highly ordered, pseudo-nematic phase during deposition can be obtained by depositing a cellulose/PEG ink at shear rates of about 5 sec⁻¹ or greater, such as at a shear rate ranging from about 5 sec⁻¹ to about 20 sec⁻¹ on a substrate, e.g., glass, plastic (e.g., polytetrafluoroethylene), metal, or a previously deposited layer of the ink when forming a three-dimensional (3D) structure). Upon reforming of the stabilized cholesteric phase following deposition, the resulting material can reflect light in the visible spectrum, with the reflected wavelength (the visible color) of the material depending upon the cholesteric pitch of the chiral nematic phase. The left pane of FIG. 2 schematically illustrates such an embodiment, in which the chiral nematic phase of the material defines a cholesteric pitch to reflect green light to the observer. Variation in the pitch through, e.g., variation of the cellulose derivative, PEG stabilizer, etc. can thus be used to vary the perceived color of the deposited material.

In some embodiments, higher shear rates can be utilized, for instance, to provide a deposited material that can exhibit variable optical characteristics. For example, deposition of a solution so as to obtain uniform orientation of the entire chiral nematic phase can allow for the production of a structure that can reflect variation in colors with variation in viewing angles. Such variable optical characteristics can be obtained in one embodiment through deposition of a composition at a higher shear rate, e.g., a shear rate of about 20 sec⁻¹ or greater, such as from about 20 sec⁻¹ to about 200 sec⁻¹, or from about 50 sec⁻¹ to about 150 sec⁻¹, in some embodiments.

The photonic properties of materials obtained under higher shear conditions can include a cholesteric pitch trapped at an angle that is significantly offset from the normal orientation observed under low shear conditions. In such an embodiment, material close to the wall of the extrusion device (e.g., a print head nozzle wall) can maintain the expected perpendicular orientation. However, the orientation of the material can become progressively parallel to the flow direction toward the center of the extruded material. This change in orientation induced by the flow dynamics across the material during deposition can result in a change of director angle with respect to the material surface following reforming of the stabilized cholesteric phase following deposition, causing the reflected wavelength to become significantly dependent on the viewing angle. Such an embodiment is schematically illustrated in the right panel of FIG. 2.

Printing parameters can also be used to modify the printed structures. For instance, following deposition and drying, regions of a material that selectively reflect particular color may be adjusted by simply changing the infill geometry and/or by modifying deposition characteristics (e.g., shear rate) during formation of a structure. Solids with such unique properties highlight attractive qualities of structurally color materials and responsive optical materials as may be formed according to disclosed processes.

Following deposition, the ink can be allowed to recover the stabilized cholesteric phase, for instance, by sitting for a period of a few minutes. Following this period, solvent of the deposited ink can be removed to provide a solid phase product. More specifically, solvent can be removed in a fashion so as to arrest the pitch of the PEG-stabilized chiral nematic phase and to prevent collapse and loss of optical properties.

In some embodiments, a material can be further treated following drying to exhibit modified optical or mechanical characteristics. The arrest of the cholesteric pitch can be obtained by exposing a deposited ink to high drying temperatures and rapid heating rates. For instance, a deposited ink can be dried at a temperature of about 50° C. to about 120° C., such as from about 60° C. to about 110° C., or from about 60° C. to about 105° C., in some embodiments. To achieve a rapid heating rate, a substrate carrying the deposited ink can be located in a pre-heated oven or the like, which is already at the desired drying temperature. In other embodiments, the substrate can be located in an oven and ramped up to the desired drying temperature at a relatively fast rate, e.g., about 10° C./minute or greater. The kinetics of solvent removal from the deposited ink can play a role in determining the final cholesteric pitch of the solid product, with higher temperatures allowing kinetic arrest to occur at larger pitch values. The stabilization provided by increased heating rate can propagate throughout the drying process, with the spectra obtained after reaching temperatures of approximately 55° C. remaining essentially constant as the deposited material transitions from the solution to the solid state. Without wishing to be bound to any particular theory, it is believed that the chiral phase trapping and stabilization phenomenon are related to the sol-gel transition that occurs slightly above the lower critical solution temperature (LCST).

The characteristics of the stabilizing PEG included in the composition (e.g., molecular weight and addition content) can combine with the drying conditions to physically arrest the pitch of the materials at a desired periodicity by controlling the spacing of the cholesteric layers. Moreover, and as discussed in more detail in the examples section, below, it has been found that not only does the addition of PEG allow for the cholesteric pitch to be controlled at a single drying temperature, it can also expand the temperature range at which a given pitch range can be captured in a dried material.

Modified optical and/or mechanical characteristics can also be attained by the addition of one or more polymerizable monomers to the dried materials followed by polymerization of the monomers. To infiltrate a material with the desired monomers following deposition and drying, the solid-phase material can be soaked in a solution of the polymerizable monomers, optionally in conjunction with increased pressure. Upon the infiltration and subsequent polymerization, the resulting polymer can provide a desired effect to the materials. Polymerizable monomers may be of any known type. In one embodiment, for example, monomers can include a polymerizable group such as acrylate, methacrylate, acrylamide, thiol, N-vinyl amide groups, or any combination thereof. As such, a polymerizable moiety can include any combination of reactive functionality such as alkene-alkene, thiol-ene, thiol-thiol, methacrylate-methacrylate, etc.

Polymerizable monomers in one embodiment can be selected to form an elastomeric polymer. Inclusion of an elastomeric polymer in a solid-phase construct can increase flexibility of the construct, which can be utilized to design mechanical force responsive structures which can change optical characteristics upon deformation. Increased flexibility of the material can allow the solidified material to be bent, which can alter the geometry of the cholesteric phase of the material. This can invoke an optical response from the material as the tilted helical axis aligns at an angle normal to the observer. Increased flexibility of the materials can also provide for additional applications due to the mechanical characteristics of the materials.

Examples of polymerizable monomers can include alkyl or hydroxyalkyl acrylates, for example, methyl acrylate, ethyl acrylate, butyl acrylate, 2-phenoxy ethyl acrylate, 2-ethylhexyl acrylate (2-EHA), 2-(2-ethoxyethoxy)ethyl acrylate (EOEOEA), 2-hydroxyethyl acrylate (2-HEA), isobornyl acrylate, methyl and ethyl acrylate, lauryl-acrylate, ethoxylated nonyl-phenol acrylate, and diethylene-glycol-ethyl-hexyl acylate (DEGEHA). Methacrylated monomers are likewise encompassed herein, e.g., methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate, and tetradecyl (meth)acrylate.

When included, a polymerizable monomer component can generally be provided in an amount of about 40 wt. % or less of the dried solid phase material, such as from about 10 wt. % to about 30 wt. %, or from about 15 wt. % to about 25 wt. %, in some embodiments.

To encourage polymerization of the monomers following infiltration, a solution of the polymerizable monomers can also include a polymerization initiator, e.g., a photoinitiator, a thermal initiator, or combinations of initiators.

Examples of photoinitiators include, but are not limited to, photoinitiators available commercially from Ciba Specialty Chemicals, under the IRGACURE® and DAROCUR® trade names, such as IRGACURE® 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyl)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4,4-trimethyl pentyl)phosphine oxide and 2-hydroxy-2-methyl-1-phenyl-propan-1-one), and 819 [bis(2,4,6-trimethyl benzoyl)phenyl phosphine oxide] and DAROCUR® 1173 (2-hydroxy-2-methyl-1-phenyl-1-propan-1-one) and 4265 (the combination of 2,4,6-trimethylbenzoyldiphenyl-phosphine oxide and 2-hydroxy-2-methyl-1-phenyl-propan-1-one); and the visible light [blue] photoinitiators, dl-camphorquinone and IRGACURE® 784DC. Other exemplary photoinitiators can include alkyl pyruvates, such as methyl, ethyl, propyl, and butyl pyruvates, and aryl pyruvates, such as phenyl, benzyl, and appropriately substituted derivatives thereof. Combinations of these materials may also be employed herein.

Actinic radiation used to polymerize the monomers can in one embodiment have a wavelength from about 200 nm to about 1,000 nm. Useful UV includes, but is not limited to, UVA (about 320 nm to about 410 nm), UVB (about 290 nm to about 320 nm), UVC (about 220 nm to about 290 nm) and combinations thereof. Useful visible light includes, but is not limited to, blue light, green light, and combinations thereof. Such useful visible lights have a wavelength from about 450 nm to about 550 nm.

In some embodiments, a solution can include a thermal initiator. Examples of thermal polymerization initiators can include, but are not limited to, azo compounds such as, for example, azo isobutyronitrile (AIBN), 1,1′-azobis(cyclohexanenitrile), 1,1′-azobis(2,4,4-trimethylpentane), C—C labile compounds, such as benzopinacole, peroxides, and mixtures thereof. Other suitable thermal polymerization initiators can include peroxide initiators, persulfate initiators, and redox (oxido-reduction) initiators. Exemplary thermal polymerization initiators can include, without limitation, potassium persulfate, percarbonates (e.g., di-t-bulypercarbonate, di-2-ethylhexylpercarbonate, monopercarbonates), peroxy esters (e.g., t-buyl per benzoate, 2-ethylhexyl perlaurate), diacylperoxides (e.g., benzoylperoxide, lauroyl peroxide), dialkylperoxides, hydroperoxides, etc.

When included, a polymerization initiator can generally be included in a solution of the polymerizable monomers in an amount of from about 0.01 wt. % to about 10 wt. %, or from about 0.1 wt. % to about 5 wt. %, or from about 0.5 wt. % to about 3 wt. %, in some embodiments.

In some embodiments, a solution can include a crosslinking agent. The crosslinking agent is not particularly limited and generally can include any aromatic, alicyclic, and/or aliphatic polyfunctional alcohol, carboxylic acid, amine, or combination thereof.

Exemplary diols useful as crosslinking agents can include, without limitation, aliphatic diols such as ethylene glycol, 1,2-propylene glycol, 1,3-propylene glycol, 2,2-dimethyl-1,3-propane diol, 2-ethyl-2-methyl-1,3-propane diol, 1,4-butane diol, 1,4-but-2-ene diol, 1,3-1,5-pentane diol, 1,5-pentane diol, dipropylene glycol, 2-methyl-1,5-pentane diol, and the like. Aromatic diols can also be utilized such as, without limitation, hydroquinone, catechol, resorcinol, methylhydroquinone, chlorohydroquinone, bisphenol A, tetrachlorobisphenol A, phenolphthalein, and the like. Exemplary cycloaliphatic diols as may be used include a cycloaliphatic moiety, for example 1,6-hexane diol, dimethanol decalin, dimethanol bicyclooctane, 1,4-cyclohexane dimethanol (including its cis- and trans-isomers), triethylene glycol, 1,10-decanediol, and the like.

Exemplary diamines that may be utilized as crosslinking agents can include, without limitation, isophorone-diamine, ethylenediamine, 1,2-, 1,3-propylene-diamine, N-methyl-1,3-propylene-diamine, N,N′-dimethyl-ethylene-diamine, and aromatic diamines, such as, for example, 2,4- and 2,6-toluoylene-diamine, 3,5-diethyl-2,4- and/or -2,6-toluoylene-diamine.

Specific examples of polyfunctional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid.

When included, a crosslinking agent can generally be present in a solution of the polymerizable monomers in an amount of about 5 wt. % or less, such as about 0.01 wt. % to about 5 wt. %, or from about 0.1 wt. % to about 4 wt. %, or from about 0.2 wt. % to about 3 wt. %, in some embodiments.

In one embodiment, PEG of the materials can include a reactive functionality that can exhibit reactivity to a polymerizable monomer. For instance, a polymerizable monomer can be provided in a solution in a mass ratio of monomer to a functionalized PEG of the solidified materials of from about 3:4, such as from about 3:5 to about 4:5.

In one embodiment, a PEG can include acrylate groups on an end of PEG chains that can be available for reaction with polymerizable monomers following drying of the materials. The acrylated PEG can polymerize with the polymerizable monomers under suitable reaction conditions (e.g., presence of an initiator in conjunction with thermal or photonic reaction conditions). The polymerized network can then provide the desired characteristic, e.g., flexibility, to the solid-phase product.

PEG diacrylate (PEGDA) is a common configuration of acrylated PEG that can be utilized, which includes the linear PEG chain flanked by terminal acrylate groups at each end. Multi-arm PEG acrylate configurations, which comprise PEG molecules with multiple branches of acrylate-capped PEG chains extending from a common core, are also encompassed herein.

In some embodiments, a solidified material can be further treated to remove any additional solvent. For instance, a solid-phase, dried material can be placed into a desiccator and held under vacuum to obtain additional solvent removal.

The properties of the cellulose/PEG inks and solid-phase structures that can be formed therefrom can have application in multiple fields, from use as coatings in architecture or textile, fashion to sensing/responsive material applications. In addition, these materials can have application in medical fields as they can be formed exclusively from biocompatible materials. Furthermore, disclosed materials and production methods can be relatively inexpensive, for instance, when compared to the costs involved in traditional coloring techniques.

The present invention may be better understood with reference to the examples, set forth below.

### EXAMPLE 1

HPC solutions including HPC content ranging from 57 wt. % to 67 wt. % (HPC Mw=100 kDa) were formed. To form the solutions, the desired quantities of HPC and water were measured in mixing cup, with HPC always being added to water to avoid nonhomogeneous mixing. Immediately after the components were combined in the mixing cup, samples were mixed in a planetary centrifugal mixer (FlackTek SpeedMixer®, DAC 330-100 SE) for 1 minute at 3000 RPM. Samples were then removed and allowed to rest for approximately 3 to 5 minutes before mixing a second time at 3000 RPM for 1 minute. The bubble-filled solutions were then centrifuged in 10-minute intervals at 8000 RPM (Fischer Scientific, Sorvall™ Legend™ X1R Centrifuge) until the solutions were bubble free, typically 1 or 2 rounds.

For all solutions described in the Examples, after mixing/centrifuging, all samples were stored in a dry, dark environment at room temperature and allowed to equilibrate for at least 3 days before use. The efficacy of the mixing step and suitability of the storage conditions were estimated by sealing the various compositions in glass vials to monitor the appearance of the solutions over time. The characteristic color initially observed for each composition was maintained over the course of several months, suggesting that the mixing procedure produced homogeneous solutions that are stable for extended periods of time that well exceed the storage time of the samples to be used for experiments or characterization.

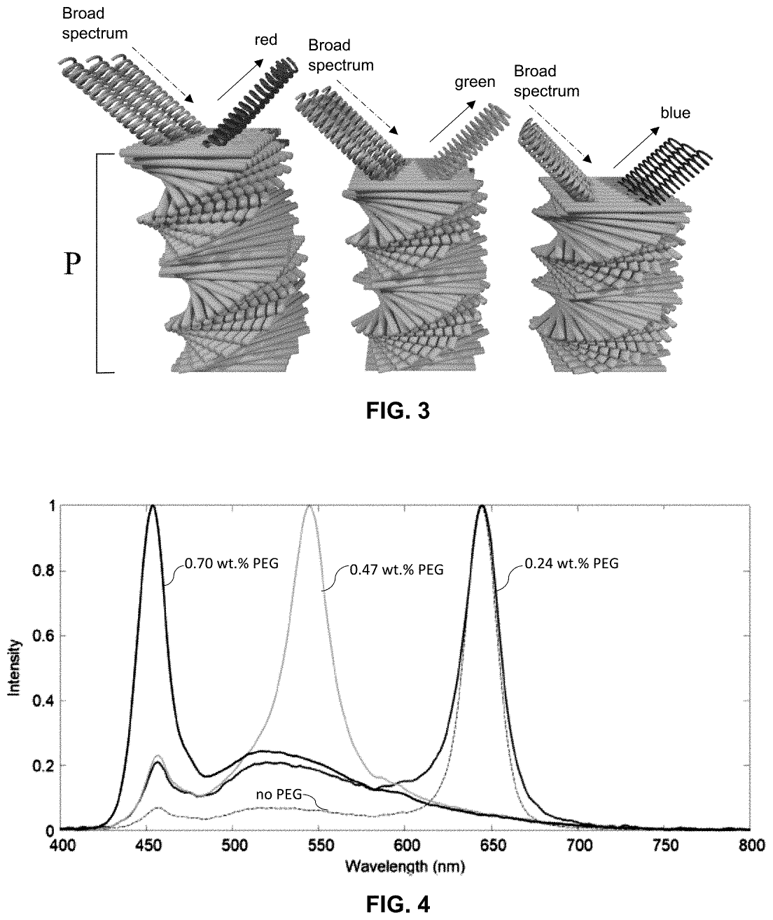

As the HPC concentration increased, the solutions became increasingly hydrophobic and polymer/solvent interactions were substituted for more favorably polymer/polymer interactions. This reduced the number of water molecules in the solvation layers of the HPC chains while increasing the strength of the polymer/polymer interactions, causing the helical pitch of the liquid crystal phase to shrink and the reflected wavelength to blueshift, as schematically illustrated in FIG. 3.

Changes in pitch length with respect to HPC concentrations have been shown to follow power law relation:

$$\frac{1}{P} ∝ {ϕ}^{x}$$

in which
P is the length of the helical pitch, measured as the distance over which the cholesteric layers complete 2πt rotation;
ϕ is the polymer volume fraction; and
X is a parameter that determines the pitch rate of change with respect to HPC concentration.

The spectral data of the HPC solutions yielded a power law exponent of 2.99. The optical properties of the HPC solutions were used as a reference state to examine characteristics of the solutions with PEG incorporated into the system.

### EXAMPLE 2

Solutions were formed including HPC and PEG of different weight average molecular weights. HPC/PEG solutions were made following the same general protocol as the HPC solutions described in Example 1. The only difference being that the desired quantity of PEG was added to the mixing cup after the water and before the HPC, allowing the liquid components to mix before introducing the HPC powder. All other steps remained the same.

Characteristics of representative PEG-containing solutions are shown in Table 1, below, including color approximations.

TABLE 1

| HPC | 200 Da PEG | | | 2 kDa PEG | | | 20 kDa PEG | | |
|---|---|---|---|---|---|---|---|---|---|
| (wt. %) | (wt. % color) | | | (wt. % color) | | | (wt % color) | | |
| 59 | 2.5 | 7 | 11 | 1 | 1.5 | 2 | — | — | — |
| 61 | 1 | 3 | 5 | 1 | 1.5 | 2 | 0.24 | 0.47 | 0.7 |
| 63 | 2.5 | 7 | 11 | 0.5 | 1 | 1.5 | — | — | — |

Intensity vs. wavelength values for solutions including the 20 kDa PEG additive are shown in FIG. 4.

Across all solutions, the results demonstrated that shorter wavelength colors were obtained upon increasing the PEG concentration and that higher molecular weight PEG required less PEG additive to induce color change in the solutions. The ability of the HPC/PEG solutions to form photonic solutions indicated that self-assembly of the chiral nematic phase was not hindered by the addition of PEG. Increasing PEG concentrations resulted in a blueshift of reflected wavelength as in the case of the pure HPC solutions.

### EXAMPLE 3

HPC/PEG solutions were formed as described above including a 100 Da PEG at concentrations ranging from 1 to 11 wt. %.

The dependence of the reflected wavelength on PEG composition displayed a more non-linear behavior compared to pure HPC solutions. For instance, the 100 Da PEG compositions up to 7 wt. % displayed a subtle blueshift with increasing concentration while a much larger blueshift was observed from 9 to 11 wt. %.

The photonic behavior of the HPC and HPC/PEG samples were compared based on total polymer concentration. Values for the peak reflected wavelengths of the solutions were obtained by use of the power law relation as discussed above and using the power law exponent obtained from the pure HPC reference materials (x=2.99) in conjunction with the known relationship of wavelength of reflection to the refractive index and microstructure periodicity, or helical pitch, i.e.:

λ=Pn cos (θ)

in which
λ is the reflected wavelength;
P is the pitch length as defined above;
n is the mean refractive index of the material; and
θ is the angle of incident light with respect to the axis of a given helix.

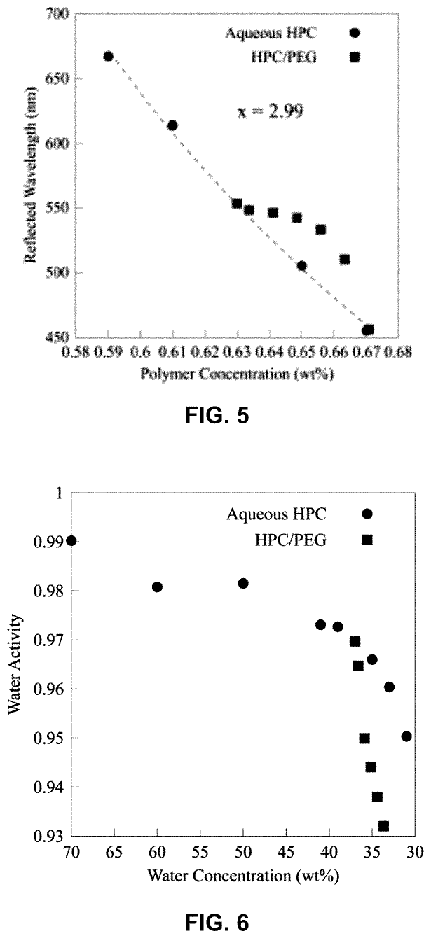

Results are illustrated in FIG. 5, which demonstrates the reflected wavelength (nP when θ=0 in the above equation) as a function of HPC wt. %.

The spectral data show that HPC/PEG solutions reflect longer wavelengths of light than pure HPC solutions over the same range of polymer concentration, suggesting that the addition of PEG counters pitch compression, particularly at concentrations below 9 wt. %.

Differences in polymer/solvent interactions were further investigated using water activity measurements. Results are provided in FIG. 6. In both pure HPC and HPC/PEG solutions, water activity decreased with increasing polymer concentration, indicating an increasing fraction of bound water in the system. In pure HPC solutions, a noticeable difference in the rate of change in water activity with HPC concentration was observed across isotropic (30 wt. %), biphasic (40-50 wt. %), and fully anisotropic solutions (59-69 wt. %). The addition of PEG to anisotropic HPC solutions caused the water activity to decrease to lower values at a more significant rate, indicating a higher degree of solvent structure compared to pure HPC solutions.

Rheological characterization was carried out on HPC/PEG solutions. Experimental conditions were selected to mimic those used in a typical casting or direct ink writing (DIW) procedure in which the sample has been stored for at least 3 days before use. Evaluation of solutions with a common shear history was accomplished by performing a zero-shear conditioning step for 10 minutes, allowing sufficient time for the recovery of the chiral nematic phase. All experiments included the use of a solvent trap to prevent water evaporation. Solutions used in rheological experiments were kept in the centrifuge tube to avoid any shear orientation that may occur while loading the samples from a syringe.

Rheological measurements (TA Instruments, Discovery HR-2) were conducted using a cone and plate geometry (40 mm, 2° cone) at 25° C. An empty solvent trap was used to minimize evaporation from the sample during characterization. A fresh sample was loaded for every test to ensure using samples with same shear history.

All experiments were preceded by a 10-minute equilibration step before beginning the test. Flow tests were carried out at shear rates from 0.01 s⁻¹ to 500 s⁻¹. Amplitude sweeps were performed at a constant angular frequency of 10 rad/s for applied strain ranging from 0.01 to 100%. Frequency sweeps were conducted at a strain of 0.1% (determined from the linear viscoelastic region observed in amplitude sweeps) as the angular frequency was ramped down from 100 to 0.01 rad/s. Relaxation experiments were performed using the following procedure: First, a shear step (0 to 17.2 s⁻¹, 20 seconds) was performed to mimic the shear deformation experienced by solutions in a printing process. Immediately after completing the shear step, an oscillation time sweep was performed at a strain of 0.1% until the complex viscosity reached a steady state value.

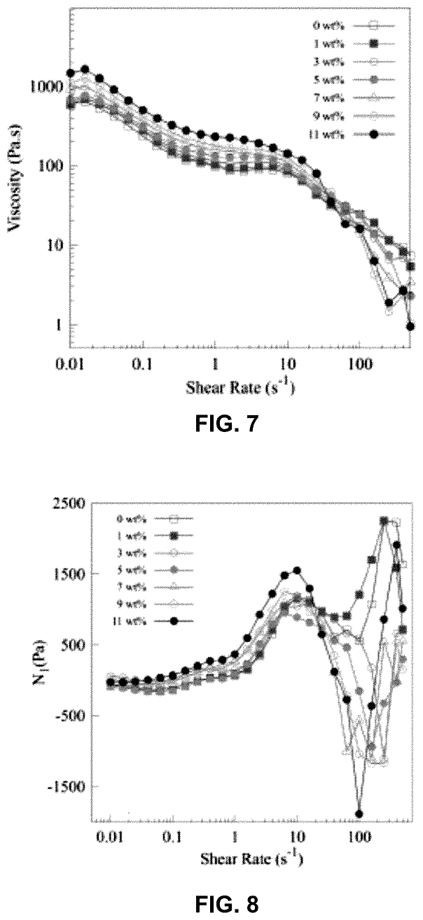

Flow sweeps in FIG. 7 show the viscosity dependence on shear rate for both the pure HPC baseline solution and HPC/PEG solutions with PEG concentrations ranging from 1 to 11 wt. %. All solutions display the three characteristic regions of flow behavior observed in lyotropic liquid crystals where two shear thinning regions, observed at low and high shear rates, are separated by a plateau region at intermediate shear rates. Each region corresponds to different configurations of the cholesteric domains. In Region I, low shear rates do not provide enough energy to alter the orientation of the microstructure; instead, weak interactions between chiral domains are broken allowing domains to flow past one another. In Region II, domains are oriented with the helical axis normal to the flow direction. The transition to Region III is associated with the uncoiling of the cholesteric structure followed by the formation of a pseudo-nematic phase, which is the desired state to be induced by deposition techniques.

The specific shear rate at which the pseudo-nematic phase develops can be determined for a particular composition from measurements of the first normal stress difference (N1), where a change in the director field and/or change in the order parameter results in negative N1 values. Negative N1 value is associated with a critical shear rate at which the director is completely aligned, and the maximum degree of order is obtained. Further increasing the shear rate does not affect the director orientation but instead can reduce the time required for the cholesteric structure to recover due to the shear thinning behavior and relatively low viscosity of the solutions at higher shear rates, providing less resistance to the recovery of the cholesteric structure.

FIG. 8 shows the dependence of N1 on the applied shear rate. All solutions showed an initial decrease in N1 followed by a steady increase to some maximum value between 5 and 20 s⁻¹, with solutions containing higher PEG concentrations displaying an inflection point at lower shear rates, before making a transition toward a local minimum value. The inflection points indicate a shift toward negative or decreasing N1, and a change in director dynamics towards a pseudo-nematic state, all in approximately the same range (about 15 to 20 s⁻¹). Inconsistencies were attributed to a number of factors including different HPC sources (Sigma Aldrich vs. Nippon Soda), sample concentrations (50 wt. % vs. 63 wt. %) and testing conditions (pre-shear/ramp vs. flow sweep).

The three regions observed in the viscosity curves for all HPC/PEG solutions support the understanding that PEG does not hinder the development of the chiral nematic phase; rather, the chiral nematic phase is maintained, even as the PEG content within the system is increased.

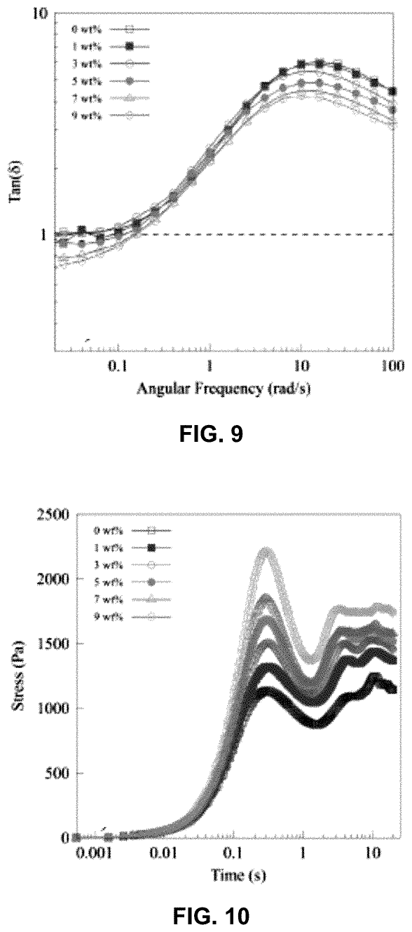

The physical network was further evidenced by the descending frequency sweeps shown in FIG. 9, which simulate solution behavior after being exposed to shear forces during a casting or DIW processes. Here, the high frequency regime described the solution shear thinning behavior during the deformation process, while the low frequency regime captured solution behavior at, or near, the point of flow cessation. The pure HPC reference sample displayed liquid-like behavior over the entire frequency range and never recovered to a gel-like state even at the lowest frequencies where the ratio of the loss to storage modulus, or tan(δ), approached 1. The hydrogen bonding network that developed between HPC and PEG resulted in the recovery of a gel-like state from the liquid-like state, with the transition point being reached at higher frequencies for samples with higher PEG concentrations.

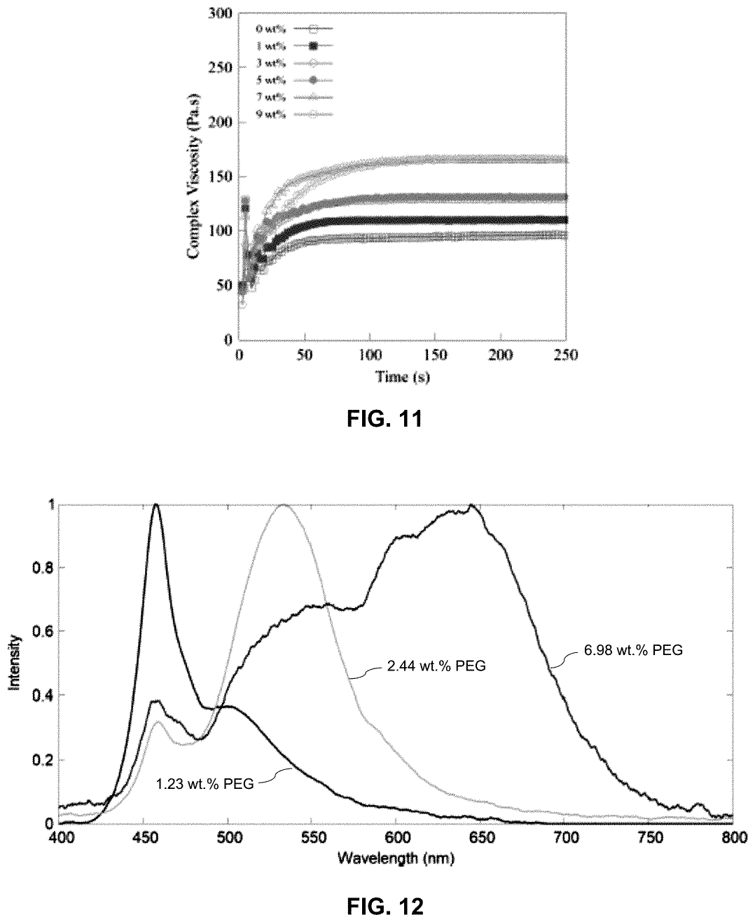

Following deposition, solutions recover the chiral nematic phase over a period of time which is dependent on the PEG concentration. These times were estimated by simulating the shear conditions of the deposition process. Solutions were sheared at 23 s⁻¹ for 17 seconds to mimic the applied shear rate and residence time of the solution in a DIW nozzle (FIG. 10). All solutions displayed a large initial stress response which oscillated at magnitudes dependent on PEG concentration. This oscillatory effect was less significant for solutions containing higher PEG concentrations, suggesting the addition of PEG helps to truncate the oscillatory flow regime observed in HPC solutions under transient conditions. Immediately after applying the shear step, oscillation measurements were performed to monitor the time evolution of the complex viscosity (FIG. 11). The time required for each solution to achieve a steady state complex viscosity was considered as the minimum time required for recovery of the chiral nematic phase. The minimum recovery times ranged from 90 seconds for the pure HPC reference sample to 190 seconds for solutions containing 11 wt. % PEG. In further examples, to ensure full recovery of the chiral nematic phase, solutions were allowed to rest for 5 minutes before drying.

### EXAMPLE 4

Solid samples were formed from inks described previously. All HPC/PEG samples included 100 Da PEG. Structurally colored solids were obtained using blade coating or DIW processing methods. Solutions were deposited onto glass slides using one of the methods and then promptly covered for 5 minutes to mitigate solvent evaporation during the recovery of the chiral nematic phase. DIW samples were printed (Hyrel™ 3D System 30 M printer) from a 5 mL syringe using a blunt needle (gauge 18). Printing parameters such as print speed (4 mm/s), layer height (0.5 mm), % infill (70), bed temperature (25° C.), and flow multiplier (1×) were held constant for all pints. Shear rates of approximately 23 s⁻¹ were implemented to ensure shear rates across the solutions were maintained within outlined shear rate range as discussed previously. After solutions had been printed, the samples were covered using a petri dish lid and allowed to rest for the minimum amount of time required for structural recovery (rest times obtained from relaxation experiments described previously).

Following the rest period, samples were dried in a pre-heated oven at temperatures ranging from 70° C. to 103° C. in a vacuum oven (Yamato, ADP210C vacuum drying oven). Samples were placed on a drying rack and allowed to dry for 2 hours, after which point the reflected color of the sample remained constant. Extended drying times at a given temperature made no difference in the final color of the prints.

A polarized Zeiss® Axioscope™ X5 optical microscope (Oberkochen, Germany) was used to capture reflection images of both liquid and solid samples. Spectral analysis was performed using a spectrometer attachment (Flame UV-Vis, Ocean Insight) viewed under a 50×objective. Liquid samples were sandwiched between glass slides and allowed to rest for 15 minutes before images were captured. All images were taken from the center of the sample to avoid discrepancies that may arise due to edge evaporation.

A UV-visible spectrometer was used to obtain transmittance spectra of printed samples. All samples were analyzed as printed, on a glass slide, with baselines corrections made to account for any interference caused by the substrate.

Atomic force microscopy was performed at room temperature using a TT-2 AFM (AFM Workshop) set to tapping mode at a scan rate of 0.5 Hz. AFM tips (ACLA-10-W, k=48 N/m, f=150 kHz) were also supplied by AFM Workshop. Cross-sections of casted films or printed filaments were prepared by slicing sections of the desired material with a razor blade. Image analysis software (Gwyddion v2.58) was used to perform two-dimensional fast Fourier transforms (2D-FFT).

Electron microscopy images were obtained using a Zeiss® Gemini™ 500 FESEM. Samples were prepared by cutting dried films with a razor blade and mounting on a cross section sample holder. All samples were sputter-coated with gold prior to imaging.

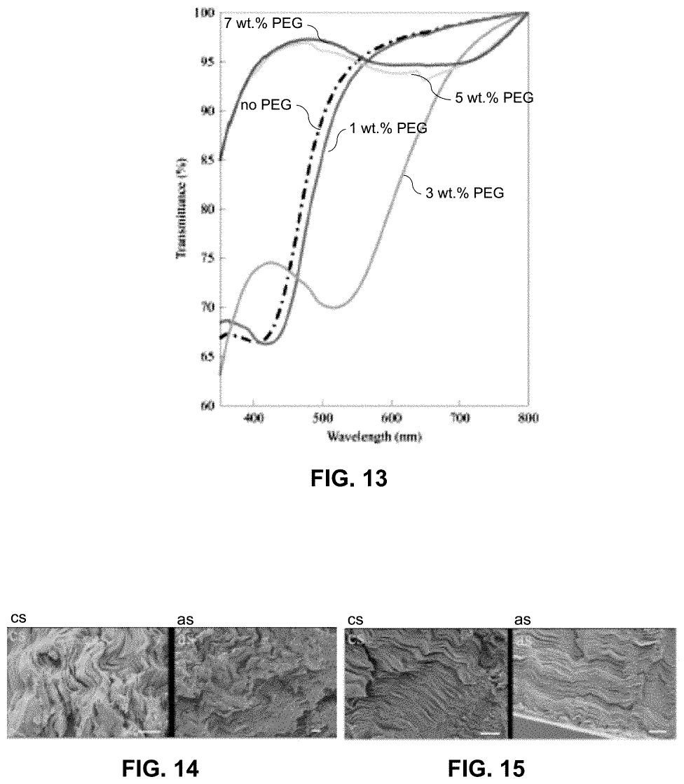

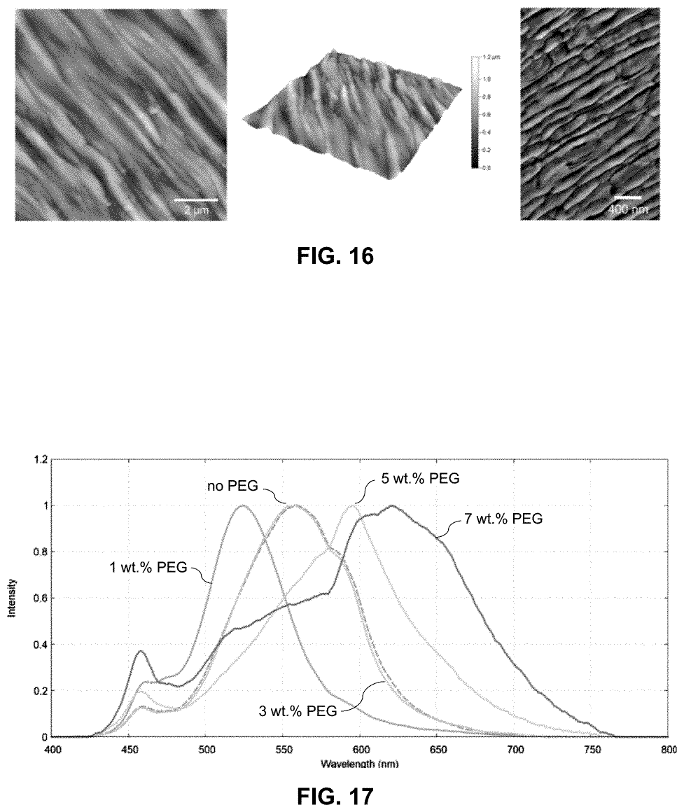

Solids including PEG concentrations ranging from 0 to 7 wt. % formed by drying at 90° C. spanned the full range of the visible light spectrum (FIG. 12, FIG. 13). The spectra showed greater intensity for samples reflecting lower wavelengths, such as blue and green, while the peaks observed for high reflected wavelengths were broader and less intense. This peak broadening suggests that the observed color stems from the coalescence of a wider distribution of pitch values compared to samples which reflect light at lower wavelengths. FE-SEM images obtained from cross-section (cs) and axial sections (as) for both blade cast films (FIG. 14) and printed filaments (FIG. 15) highlight the shear alignment capabilities offered by each processing technique. The blade cast samples (FIG. 14) were not as well aligned as those formed via DIW (FIG. 15), believed to be due to superior pseudo-nematic alignment achieved in the solution state during printing.

Printed filament cross-sections were further characterized using atomic force microscopy (AFM) to extract an average pitch value from the cross-sections. 2D and 3D height images (FIG. 15) describe the same morphology observed in FE-SEM images. However, AFM scans provide better resolution of the cholesteric pitch. By performing amplitude scans over the same area, clear images of a regularly spaced cholesteric pitch measuring approximately 300 nm in length were obtained.

Within the examined temperature range, photonic solids reflecting wavelengths of light that span the visible light spectrum were observed for HPC/PEG compositions ranging from 0 to 11 wt. %. Solids dried from pure HPC solutions required the highest drying temperature to cover the entire spectrum, producing materials of blue, green, orange, and red at drying temperatures of 90° C., 95° C., 100° C., and 103° C., respectively. As the PEG concentration of the chiral inks increased, the temperature range required to span the visible light spectrum decreased, with HPC/PEG solutions containing 7 wt. % reflecting colors from blue to red at temperatures ranging from 70° C. to 90° C.

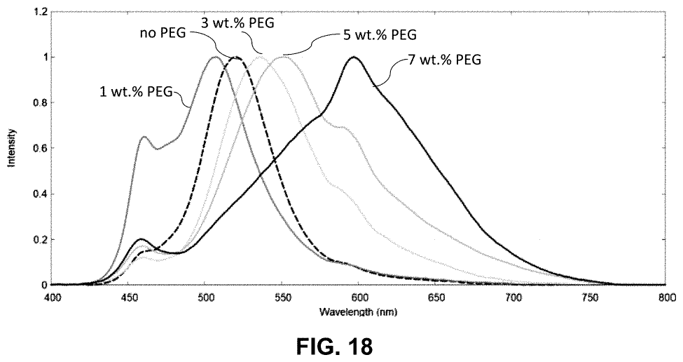

Additional optical characteristics of photonic solids are illustrated in FIG. 17 and FIG. 18. FIG. 17 presents intensity vs. wavelength data for materials formed from HPC/PEG solutions including from 0 to 7 wt. % PEG and 61 wt. % HPC. FIG. 18 shows the same data for solids formed from solutions including from 0 to 7 wt. % PEG and 63 wt. % HPC. In both cases, the solids were formed at drying temperatures of 90° C.

### EXAMPLE 5

Freestanding films which display dynamic optical properties were obtained by printing onto a polytetrafluoroethylene substrate. The DIW formation method described above was utilized with solutions containing 7 wt. % PEG, but in which the applied shear rate was approximately 100^{s-1}. The resulting materials showed drastically different optical properties compared to solids obtained from the lower shear rate. These samples showed a high degree of dependence on viewing angle and path direction of the syringe nozzle during filament deposition. At a normal viewing angle (90° C.), filaments displayed slight variations in wavelength but predominantly reflected various shades of green. However, as the sample was rotated toward (positive angle) or away from (negative angle) the observer, the filaments reflected a strong orange/red (FIG. 2).

Moreover, the samples included areas of illumination upon rotation that were associated with filaments that were deposited such that the syringe nozzle was moving toward the observer. In contrast, filaments deposited as the nozzle moved away from the observer were nearly transparent.

Transmission micrographs showed band textures that are known to develop perpendicular to the flow direction following shear cessation in HPC solutions, indicating a high degree of molecular alignment at the filament surface, causing the reflected wavelength to become significantly different dependent on the viewing angle.

### EXAMPLE 6

A solution including a chiral nematic phase was formed including HPC (Mw−40 kDa) and reactive monomer, PEGDA (Mw=575 Da).

Following deposition (via DIW) and drying of the solution as described herein, a first dried HPC/PEGDA film was transferred to a dish containing a combination of 2-HEA and 2-EHA polymerizable monomers, 1,6-hexanediol diacrylate as crosslinker (X-linker), and a mixture of IRGACURE® 813 and IRGACURE® 2595 as photoinitiator (PI) (Solution 1). The film was retained in Solution 1 for 1 hour for monomer infiltration and then cured under UV for 2-3 minutes.

A second dried HPC/PEGDA film was transferred to a dish containing a combination of 2-HEA and 2-EHA as polymerizable monomers, 1,6-hexanediol diacrylate as crosslinker, and AIBN as thermal initiator (Solution 2). The film was retained in Solution 2 for 1 hour for monomer infiltration and then cured in an oven at 60° C. for 24 hours.

The solutions included the components at the following content ratios:

(2-EHA+2-HEA)/PI=440,

(2-EHA+2-HEA+X-linker)/PI=441,

2-EHA/2-HEA=8.12,

(2-EHA+2-HEA)/X-linker=444

Casted HPC/PEGDA films were also formed of the initial cholesteric solution. Samples of the casted films were swelled in a solution of toluene and dimethylformamide (DMF) (toluene:DMF volume ratio of 10:1) for 1-2 hours. The swelled films were then retained in Solution 1 or Solution 2 as described above and cured as described.

While certain embodiments of the disclosed subject matter have been described using specific terms, such description is for illustrative purposes only, and it is to be understood that changes and variations may be made without departing from the spirit or scope of the subject matter.

What is claimed is:

1. An optically active ink comprising a solvent, a lyotropic cellulose derivative, and a polyethylene glycol in an amount of about 15 wt. % of the ink or less, wherein the optically active ink includes a chiral nematic phase comprising the cellulose derivative.

2. The optically active ink of claim 1, wherein the lyotropic cellulose derivative comprises a cellulose ether, a cellulose ester, or a combination thereof.

3. The optically ink of claim 1, wherein the lyotropic cellulose derivative comprises an alkyl cellulose, a hydroxy alkyl cellulose, a carboxy alkyl cellulose, an organic ester cellulose, an inorganic acid cellulose, or a combination thereof.

4. The optically active ink of claim 1, wherein the lyotropic cellulose derivative has a weight average molecular weight of from about 20 kDa to about 200 kDa.

5. The optically active ink of claim 1, wherein the polyethylene glycol has a weight average molecular weight of from about 100 Da to about 50 kDa.

6. The optically active ink of claim 1, wherein the polyethylene glycol comprises a reactive functionality.

7. The optically active ink of claim 6, wherein the reactive functionality comprises an acrylate.

8. A solid material comprising a chiral nematic phase including a lyotropic cellulose derivative and a polyethylene glycol, wherein the solid material comprises the cellulose derivative in an amount of about 70 wt. % or more and comprises the polyethylene glycol in an amount of about 30 wt. % or less, the solid material reflecting light in the visible spectrum.

9. The solid material of claim 8, wherein a wavelength of the reflected light varies with an angle measured from a surface of the solid material.

10. The solid material of claim 8, further comprising an elastomeric polymer.

11. The solid material of claim 10, wherein the elastomeric polymer is bonded to the polyethylene glycol.

12. The solid material of claim 8, wherein the solid material comprises a printed pattern.

13. The solid material of claim 8, wherein the solid material is in the form of a three-dimensional printed structure.

14. A method for forming an optically active solid structure, comprising:
depositing an ink on a substrate at a shear rate of about 5 sec⁻¹ or greater, the ink comprising a lyotropic cellulose derivative in an amount of about 50 wt. % or more by weight of the ink, the ink further comprising a polyethylene glycol in an amount of about 15 wt. % or less by weight of the ink; and
drying the deposited ink at a temperature of about 50° C. or greater; wherein
subsequent to depositing the ink, the ink comprises a chiral nematic phase that includes the lyotropic cellulose derivative.

15. The method of claim 14, further comprising combining the lyotropic cellulose derivative and the polyethylene glycol with a solvent to form the ink.

16. The method of claim 14, wherein the depositing is carried out according to a direct ink writing deposition technique.

17. The method of claim 14, wherein the ink is deposited in multiple layers.

18. The method of claim 14, wherein the ink is deposited at a shear rate of about 20 sec⁻¹ or greater.

19. The method of claim 14, further comprising infiltrating the dried ink with polymerizable monomers and subsequently polymerizing the monomers to form a polymer within the optically active solid structure.

20. The method of claim 19, wherein the polymer is an elastomeric polymer.
